(19) United States
(12) Patent Application Publication
(10) Pub. No.: US 2021/0051125 A1
(43) Pub. Date: Feb. 18, 2021

(54) SYSTEM FOR FILTERING AND MANAGING USER'S GENERATED TEXTUAL CONTENT ON SOCIAL NETWORKS

(71) Applicant: Data Wow Co., Ltd., Bangkok (TH)

(72) Inventor: Putt Kraidej, Mueang Phichit (TH)

(21) Appl. No.: 16/667,266

(22) Filed: Oct. 29, 2019

(30) Foreign Application Priority Data
Aug. 16, 2019 (TH) 1901005026

(51) Int. Cl. H04L 12/58; G06Q 50/00

(52) U.S. Cl. CPC H04L 51/12; G06Q 50/01; H04L 51/32

(57) ABSTRACT

A system for filtering and managing user's generated textual content on social networks comprising a message screening, message setting, message adjusting and message classifying for the propose of processing the messages are limited in the scope as specified the said system setting wherein the invention objective is to prevent the spreading of undesirable messages on social networks.

### FIELD OF THE INVENTION

The invention relates to the field of computer engineering in relation to the system for filtering and managing user's generated textual content on social networks.

### BACKGROUND OF THE INVENTION

Nowadays, conversations used on social networks comes in variety of languages moreover there are words, languages or symbols that have been used in replacement of general conversation wherein the conversations made on social networks are often adjusted, distorted, shortened for several purposes; for example, summarizing message to make it easy to understand, creating new symbols, creating new languages (new vocabularies), creating some vocabularies for certain group as well as adjusting message to avoid being filtered out which is generally conducted on social networks to initially screen the information before the message is made public to prevent any undesirable, immoral, illegal comment or cause of any disgrace or damage.

Messages are often adjusted to avoid, conceal, confuse undesirable information or message content to social network user or to make it faster to send the message to the intended recipients wherein the adjustment of those messages might go further from the original message sent by sender and it is harder to be filtered by initial methods in order to screen the content accurately since the initial filtering system is created to filter natural languages that contain grammar and word structure that are complete and correct in accordance with the grammar regulation default setup in the database which will be compared to what is specified wherein, according to the search results, some similar patent applications have been found as follows:

Thai patent application number 1001000484 of the invention titled “System and method for analyzing comment automatically” illustrates message analytical system comprising a collection of words and patterns of comment on the database and analysis of comment and statistical result display. After analyzing all message, the system will provide statistical analysis and display results to user wherein said invention is a system for initial analysis of user's comment.

Thai patent application number 1401005705 of the invention titled “Tool for cutting and converting Thai words and method thereof” illustrates system and method for cutting and converting words into normal form comprising process for analyzing frequency and probability of single and double words, cutting and converting of words in the correct grammar form, which helps select a path of words by creating tree structure of all possible paths and selecting the most possible path by filtering from collected statistics wherein said system filters only a message containing normal characters but it cannot filter a message containing symbols or other characters.

US patent application number US20190028499A1 of the invention titled “System and method for AI-based anti-fraud user training and protection” illustrates system for analyzing content of collected electronic message and calculating security score to prevent people at high risk from damage in case of real attack wherein the content analysis emphasizes on security filtering in sending the message only.

As mentioned above, it has been found that there are many types of system for filtering information such as security filtering, grammatical correctness filtering and messages' comments filtering wherein the inventor provides great development of specific filtering method on social networks and screens the message which is intended to avoid wherein the accuracy of the filtering is as high as native speaker.

### SUMMARY OF THE INVENTION

System for filtering and managing user's generated textual content on social networks according to the present invention comprises the following main process: message screening, message specifying and adjustment, message classification, and processing to filter if the message is in the scope of undesirable message as specified wherein said system is developed to have the same level of correctness and accuracy as universal language and Japanese.

The purpose of this invention is to create system for screening message on social networks by which the level of accuracy is the same as native speaker to prevent the spreading of undesirable message wherein said system can filter words, emoticons, symbols as well as every single combinations of character of different languages which refers to any intended words in order to reduce the message filtering manually by a person visually screening out the unwanted message the which can be time consuming and causes health effect.

### BRIEF DESCRIPTION OF THE DRAWINGS

FIG. 1 illustrates one embodiment of system for filtering and managing user's generated textual content on social networks.

### DETAILED DESCRIPTION OF THE INVENTION

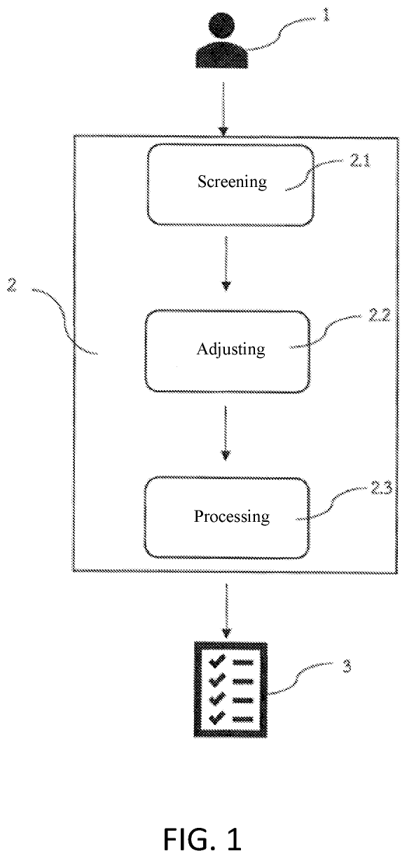

According to FIG. 1, it illustrates one embodiment of system for filtering and managing user's generated textual content on social networks which is developed as a tool to filter message or information in replacement of the filtering by human eyes which has language limitation since it requires native speaker in each country to perform the filtering process which have high costs and to reduce mistake and filtering time wherein the process of system for filtering and managing message comprises user, message filtering system and filtering results as follows:

The user 1 who is provided with the access to social networks is required to register wherein, before starting to use, user is provided to register to the system to be able to comment, receive message, and send message via social networks wherein the giving of comments, the receiving of message, and the sending of message can be done within the same site or any other sites of social networks based on its term wherein when user's 1 message shows on social networks, said message will be sent to message filtering system 2 immediately for filtering when the message or information is made public.

The message filtering system 2 acts as a medium of messages filtering on social networks wherein it is a database storing comments, messages, and user's 1 data wherein the message filtering system 2 comprises screening 2.1, adjusting 2.2, and processing 2.3 steps which contain the following process:

The screening step 2.1 which provides initial message filtering wherein it is provided to filter by words, emoticons, symbols as well as every single combining character which refers to any intended words that might contain various languages, pictures or symbols similar to some certain characters intended to give them meaning.

The adjusting step 2.2 which provides message adjustment into a specified form wherein when receiving screened 2.1 message, there will be filtering and adjustment of symbols into characters of language specified for a filtering in the filtering system 2 which collects information and words of languages, universal language and Japanese, for the filtering system 2 to compare the information and provide further processing 2.3 easily.

The processing step 2.3 configures to filter messages that have been adjusted into universal language or Japanese wherein the processing 2.3 is developed from the processing principle of natural language and learning principle of filtering system 2 which undergo the processing 2.3 to categorize message or information as specified by the system.

Filtering results 3 provide output from the processing 2.3 via filtering system 2 wherein the providing of output equals to specified scoring rates signifying the meaning of message or information in various undesirable aspects wherein the message summary is provided to display in numeric form from zero to one wherein one denotes that the filtered message contains the closest meaning to specified aspect and zero denotes that the filtered message does not contain any meaning in specified aspect.

The filtering system 2 can provide a score based on specified various aspects wherein the aspects that have been used the most for the message filtering can be chosen from the following categories: sex, prostitution, money-related scammer, violent content, hate speech, fake accounts, spam, terrorist propaganda, and invitation to other sites of social networks.

Examples of display:
Message content: want $ex phOne
Sexual score: 0.99
Prostitution score: 0.24
Money related scammer score: 0.01
Others social networks score: 0.16

The display can be chosen from several forms, e.g. table, chart, and graph; and as for the display of condition, it is allowed to select types of condition to be displayed and add or reduce number of conditions.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof.

### BEST MODE OF THE INVENTION

The best method of invention is as described in detailed description of the invention.

1. A system for filtering and managing user's generated textual content on social networks comprising:
a registration sub-system operable to register a user and allow the user to log in to the system;
permitting the user to send sent messages and to receive received messages on social networks;
transferring, when the sent messages or received massages are displayed on the social networks, the sent messages and the received messages to a message filtering system, wherein the sent messages and the received messages are acted upon by a screening step, an adjusting step and a processing step;
providing an output, wherein the output provides a score based on a meaning of the sent messages and the received messages in terms of one or more undesirable aspects of the respective sent messages and received messages.

2. The system according to claim 1 wherein:
the screening step provides initial message filtering by words, emoticons, symbols and combinations thereof;
the adjusting step provides message adjustment into a specified form in characters of a language for the filtering in the filtering system; and
the processing step provides the filtering of message that has been adjusted into the specified form to categorize the sent messages or the received messages as specified by the system.

3. The system according to claim 1 wherein the output includes each of the one or more undesirable aspects and a score in numeric form from zero to one.

4. The system according to claim 1 wherein the one or more undesirable aspects provided in the output include sexual, prostitution, money-related scammer, violent content, hate speech, fake accounts, spam, terrorist propaganda, and invitation to sign up for other online application on social networks.

5. The system according to claim 1 wherein the adjustment step performs an adjustment of symbols into characters of the language for the filtering system.
